(19) United States
(12) Patent Application Publication
(10) Pub. No.: US 2019/0172026 A1
(43) Pub. Date: Jun. 6, 2019

(54) CROSS BLOCKCHAIN SECURE TRANSACTIONS

(71) Applicant: Alchemy Limited LLC, Seattle, WA (US)

(72) Inventors: Peter Joseph Vessenes, Bainbridge Island, WA (US); Philip Hofer, Seattle, WA (US)

(21) Appl. No.: 16/206,713

(22) Filed: Nov. 30, 2018

Related U.S. Application Data
(60) Provisional application No. 62/593,917, filed on Dec. 2, 2017.
(60) Provisional application No. 62/593,993, filed on Dec. 3, 2017.
(60) Provisional application No. 62/611,861, filed on Dec. 29, 2017.

(51) Int. Cl. G06Q 20/06; G06Q 20/36; H04L 9/06

(52) U.S. Cl. CPC G06Q 20/0658; G06Q 20/3678; H04L 9/0637; G06Q 20/3674; G06Q 20/363

(57) ABSTRACT

Disclosed are computing devices, systems, methods to operate a cross blockchain secure token transaction engine to identify a set of one or more tokens of a first blockchain, lock the identified set of the one or more tokens of the first blockchain, and generate, based upon the locked set of the one or more tokens, a set of one or more tokens of a second blockchain, where the set of one or more tokens of the second blockchain are to be subsequently converted to tokens of the first blockchain based upon the locked set of tokens of the first blockchain.

### PRIORITY CLAIM TO PROVISIONAL APPLICATIONS

This application claims priority to U.S. Provisional Application No. 62/593,917 filed Dec. 2, 2017, to U.S. Provisional Application No. 62/593,993 filed Dec. 3, 2017, and to U.S. Provisional Application No. 62/611,861 filed Dec. 29, 2017. The specifications of all three applications are hereby incorporated by reference in their entireties.

### TECHNICAL FIELD

The present disclosure relates to transactions on a blockchain. More particularly, the present disclosure relates to cross-blockchains transactions.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Satoshi Nakamoto introduced the Bitcoin (BTC) whitepaper in 2008, and in the intervening years interest in decentralized cryptocurrencies and crypto assets has greatly increased.

Additionally, the Initial Coin Offering (ICO) has arisen as a popular fundraising tool, and its popularity will only increase as more entrepreneurs come into the blockchain environment.

### BRIEF DESCRIPTION OF THE DRAWINGS

The cross blockchain transaction techniques will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 is an example context diagram of a system to facilitate cross blockchain secure token transactions, in accordance with various embodiments.

FIGS. 2A-2B are example flow diagrams illustrating, respectively, methods for exporting and importing tokens between a Bitcoin blockchain and an Ethereum blockchain, in accordance with various embodiments.

FIG. 3 is an example detailed flow diagram illustrating a method for exporting a token on a Bitcoin blockchain to a token on an Ethereum blockchain, in accordance with various embodiments.

FIG. 4 is an example detailed flow diagram illustrating a method for exporting a token on an Ethereum blockchain to a token on a Bitcoin blockchain, in accordance with various embodiments.

FIG. 5 is an example multiple-entity timing/interaction diagram for importing Bitcoin tokens to Ethereum tokens and exporting Ethereum tokens to Bitcoin tokens, in accordance with various embodiments.

FIG. 6 is an example context diagram illustrating an interaction of validators in a Raft node implementation, in accordance with various embodiments.

FIG. 7 is an example flow diagram illustrating a method for exporting one or more tokens on a first blockchain to one or more tokens on the second blockchain, in accordance with various embodiments.

FIG. 8 illustrates an example computing device 800 suitable for use to practice aspects of the present disclosure, in accordance with various embodiments.

FIG. 9 illustrates an example storage medium having instructions for practicing methods described with references to FIGS. 1-8, in accordance with various embodiments.

### DETAILED DESCRIPTION

Apparatuses, methods and storage media associated with cross blockchain secure token transaction operations are described herein. Embodiments described herein may operate as portions of a decentralized bridge connecting blockchains to enable seamless, trust-less cross-chain asset or token transfer between the blockchains. In embodiments, the connecting block chains may include Bitcoin and Ethereum, or any other block chain implementations or technologies.

In legacy implementations in the context of crypto asset commerce, the vast majority of cross-chain transactions are executed via centralized exchanges and trusted third-party trading platforms. This approach constrains users within the bounds of a particular platform and subjects them to long transaction times, high fees, and more significant financial and logistical implications for large transactions.

In embodiments, interconnected blockchains that allow tokens to pass between and/or transactions to be synchronized across the blockchains the blockchains will enable users to access new blockchain ecosystems with the assets they already own, without needing to go through the onerous and potentially risky process of engaging centralized exchanges or buying native currencies. In addition, with expanding use of blockchain computer systems, and the explosive growth of ICOs, owners of digital assets will continue to feel the need to move their assets from one blockchain to the next in order to capture ICO growth opportunities and/or synchronize transactions across blockchains.

With the advent of smart contracts, Ethereum introduced the ability to construct application-specific logic on the blockchain network. A smart contract may include computer code that runs on top of a blockchain, where the smart contract includes a set of rules under which parties to the smart contract agreed to interact with each other. In embodiments herein, a smart contract is a decentralized entity or software program, working as a conduit between user requests submitted to the cross-blockchain secure transaction network via wallet and independent validator machines.

This innovation led to the emergence and proliferation of blockchain-based applications. However, these applications are typically native to one specific blockchain. In legacy implementations, the exchange of information is quite difficult at this relatively nascent stage in blockchain technology. Interoperability between blockchains, e.g., the decentralized transfer of tokens from one blockchain to another and/or synchronization of transactions across more than one blockchain, may allow for more advanced partnerships and complex customizations, ultimately building richer solutions without rendering existing solutions irrelevant, resulting in a simplified, yet integrated user experience.

In embodiments, the decentralized transfer of cryptocurrencies from one blockchain to another and/or synchronization of transactions across blockchains may be referred to as a cross-blockchain secure transactions network. Synchronization of transactions across blockchains may also be referred to herein as a “transfer”, though no cryptographic asset may actually be transferred, via replication or otherwise, from a first blockchain to a second blockchain. The cross-blockchain secure transactions network may also be referred to as Deluge Network™. In embodiments, the cross-blockchain secure transactions network focuses on transferring assets from and/or synchronizing transactions between the Bitcoin and Bitcoin derived blockchains to the Ethereum blockchain. Other embodiments may bridge to other blockchains. A cross-blockchain secure transactions network achieves cross-chain interoperability by, for example, by transferring and/or synchronizing behavior of a Bitcoin token (BTC) with behavior of a corresponding ERC20 token on the Ethereum blockchain (which may be referred to as a DBTC or Bitcoin on Ethereum (BOE)). This cross block chain interoperability may enable users to spend freely on the Ethereum blockchain, without assuming the risk of using centralized exchanges, paying steep fees, or completely moving their assets or tokens to another blockchain ecosystem altogether.

In embodiments, the cross-blockchain secure transactions network may liberate Bitcoin by empowering it to move as if it is available natively on the Ethereum blockchain, while mirroring its BTC value and enabling bidirectional transfer of token and other assets. The cross-blockchain secure transactions network will deliver a seamless cross-chain implementation on top of the original blockchain implementation, built on the stability and security strengths of both Bitcoin and Ethereum protocols. For example, the strengths may include: (1) using the scripting properties of Bitcoin and the smart contract properties of Ethereum; (2) building on the security of the Bitcoin and Ethereum blockchains, following the Proof of Work (PoW) consensus algorithms of the protocol for transaction validation and conflict resolution; (3) using the stack-based scripting language of Bitcoin to satisfy complex redemption conditions for Pay to Script Hash (P2SH) transactions; (4) using cryptographic properties to securely pair a BTC and Ethereum address and smart contract properties of Ethereum for verifying corresponding bitcoin and Ethereum addresses or generating log events to trigger off-chain actions.

By bridging the Bitcoin and Ethereum blockchain networks, and ultimately bridging an array of blockchains, the cross-blockchain secure transactions network embodiments described herein may become an important part of rapid, decentralized asset transfer and an extensible foundation for the crypto asset trading ecosystem while remaining free of the encumbrances so commonly associated with cross-chain interoperability.

It should be noted that these are examples of two block chains and assets that may reside within those block chains. In embodiments, any two block chains and assets residing in these block chains may be exchanged and/or otherwise transacted using one or more of the embodiments described herein.

Embodiments described herein describe two actions: (1) importing a token from BTC to DBTC and (2) exporting a token from DBTC back to BTC. As used in examples herein, DBTC is an Ethereum-resident bitcoin proxy token that mirrors its BTC value, thus allowing users to navigate the vast ERC20 ecosystem with the confidence that their DBTC can be directly converted back to BTC on a 1:1 basis (or any other basis) at any time. In some embodiments, the transaction may incur applicable network usage and transaction fees.

In embodiments, importing is the process of locking BTC in return for generating (or minting) DBTC in place of the locked BTC. In embodiments, locking BTC includes securing one or more BTC to an address so that the BTC may not be retrieved, unlocked, or otherwise used unless approved by a majority of a group of validator systems. Exporting is the process of burning (e.g., destroying) DBTC as it is returned for a BTC.

Several foundational principles may underpin embodiments described herein: (1) speed, usability, reliability, and security of the cross blockchain secure transfer network; (2) the characteristic that users maintain control of the transaction process, in that every transaction and network transmission is initiated by the user; (3) corresponding Ethereum and Bitcoin addresses are derived using the secp256k1 ECDSA (Elliptic Curve Digital Signature Algorithm) public key (transactions are only validated and executed if the addresses correspond to the same private key claiming the exchange of funds); and (4) the blockchain's number of recommended transaction confirmations is observed for finality of transaction. Public keys and private keys are a part of asymmetric cryptography, also known as public key cryptography, that uses public and private keys to encrypt and decrypt data. One key in the pair can be shared with everyone; it is called the public key. The other key in the pair is kept secret; it is called the private key.

The cross-blockchain secure transactions network wallet, or Deluge wallet, may function as the user's point of entry for the cross-blockchain secure transactions network. An advantage of the Deluge wallet may be a seamless and intuitive user experience for making cross-chain transactions while the process remains solely user-controlled and decentralized. With the Deluge wallet, users can independently manage transfers and exchanges of their Bitcoin and Ethereum cryptocurrencies and intuitively engage in the cross-blockchains secure transactions network Import/Export processes.

In embodiments, the cross-blockchain secure transaction network including a plurality of validators provides a 2-way pegging between BTC and DBTC. As discussed above, DBTC may be a ERC20 compatible token for the Ethereum network. Characteristics of the token transfer may include: (1) users are always in control—every transaction request is initiated by the user; (2) the user who submits the initial transaction request may be the only user who can receive the output of the transaction—transactions are only valid if the addresses correspond to the same private key claiming the swap; (3) validators never submit transactions, they independently construct the transaction and publish their signature to the Ethereum blockchain (however, user and the user's wallet may be responsible for submitting the claim request); and (4) Bitcoin protocol is used for the escrow of the funds to P2SH address, which requires a majority of the validator keys to unlock.

In embodiments, the Deluge wallet is a software wallet that is controlled by the user. The user runs the wallet software on the user's own computer and the wallet, generates keys, and stores them for the user's use. As such, the user bears the risk of losing keys and control of access to funds. Deluge wallet is a digital file that makes it simple to access addresses and keys that a user owns. In embodiments, if access to the wallet is lost, the contents cannot be recovered.

Deluge wallet handles multi-signature (multisig) transactions. Multisig transactions create challenges to protect transaction security, where a minimum of M keys are required out of a total of N keys overall to meet the challenge (M-of-N keys). If the challenge is met, locked bitcoins may then be unlocked, for example during a DBTC export where DBTC tokens are exchanged for BTC. The cross-blockchain secure transaction network requires multisig for releasing the funds, where the keys are validator keys associated with a plurality of validator machines. During and export transaction, Deluge wallet constructs the multisig transaction values from Ethereum network logs and smart contracts. For the multisig transaction, the signatures and transaction details are constructed by the validator's and stored in the Deluge contract or Ethereum logs.

In embodiments, the cross-blockchain secure transaction network uses multisig bitcoin security for locking Bitcoins. The Bitcoins are sent to a P2SH address by the user via the wallet interactions. The P2SH address for locking Bitcoins is stored in a smart contract and retrieved by the Deluge wallet during import (sending BTC for DBTC). An unlock process used to claim BTC requires M-of-N signatures from the plurality of independent validators.

In embodiments, the cross-blockchain secure transaction network uses a standard multisig bitcoin transaction protocol. Transactions are initiated by the user, orchestrated via the blockchain, and are only valid if majority of the independent validator's agree.

During importing (sending BTC for DBTC), user sends the user's Bitcoins to a P2SH address specified by a smart contract. The Bitcoins are then locked at this address until a future time when a user requests an export (sending DBTC for BTC). During export, the validator's independently construct and sign (with their respective private keys) the raw bitcoin transaction and post the signature to the smart contract or Ethereum logs. When enough M-of-N signatures from the validator's are posted, the smart contract generates an Ethereum event (e.g., log message) notifying the wallet. The user, via the wallet, will retrieve the validator signatures, transaction metadata, and a “Redeemscript” from the smart contract. “Redeemscript” is a list of validator public keys required to verify that the transaction was signed by M-of-N validators.

When a user sends BTC contributions to multisig, P2SH, address, the Bitcoins are locked with M-of-N (such as 2-of-3) multisig challenge statement, where the keys are retained by the validator machines. In embodiments, if a validator is compromised or key management is required, the remaining validator's can move the Bitcoins to a new P2SH address (assuming there are enough uncompromised keys). In embodiments, this may also be implemented as an off-chain process.

In embodiments, validators will be employed based on brand reputation and interest in the cross-blockchain secure transactions network.

The cross-blockchain secure transaction network is a conduit to programmable tokenized Bitcoin on Ethereum as an ERC20 token DBTC, while mirroring its BTC value. In embodiments, as discussed above, BTC and DBTC may be pegged at 1:1.

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without parting from the spirit or scope of the present disclosure. It should be noted that like elements disclosed below are indicated by like reference numbers in the drawings.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “module” or “engine” may refer to, be part of, or include an Application Specific Integrated Circuit (ASIC), a System on a Chip (SoC), an electronic circuit, a processor (shared, dedicated, or group) and/or memory (shared, dedicated, or group) that execute one or more software or firmware programs, a combinational logic circuit, and/or other suitable components that provide the described functionality.

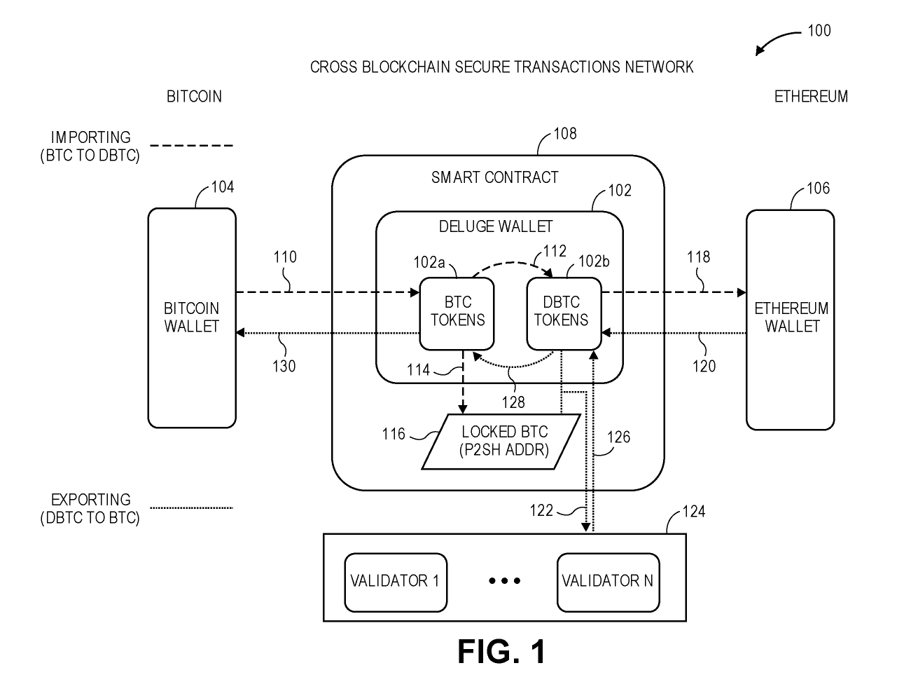

FIG. 1 is an example context diagram of a system to facilitate cross blockchain secure token transactions, in accordance with various embodiments. Diagram 100 shows a Deluge wallet 102 that may receive BTC from or send BTC to a Bitcoin wallet 104 of a user, and may receive Ethereum tokens from or send Ethereum tokens to an Ethereum wallet 106 of the user.

In embodiments, if the user wishes to use the cross-blockchain secure transactions network to transition from BTC tokens to the ERC20 compatible tokens, the user installs the Deluge wallet 102. The operation of the Deluge wallet 102 may be performed or facilitated by one or more smart contracts 108 that may operate within the Ethereum blockchain environment. The Deluge wallet 102 may include a BTC repository 102a for the user's BTC and a DBTC repository 102b for the user's DBTC. The Deluge wallet 102 may include other information as discussed in more detail below.

In embodiments, when a user wishes to initiate a transaction, the Deluge wallet 102 creates BTC and Ethereum (or ERC20 compliant) address pairs that correspond to a same public key, and stores it. If a user wishes to import tokens (eg. convert and/or synchronize BTC and DBTC), the user may perform a BTC transfer 110 from the Bitcoin wallet 104 to the BTC repository 102a, and initiate an import transaction. In embodiments, the import transaction may be initiated upon the BTC transfer 110. In embodiments, the Deluge wallet will newly mint DBTC and initiate a DBTC transfer 112 to the DBTC repository 102 based upon the BTC within the BTC repository 102a. Prior to newly minting the DBTC, an associated number of BTC will be transferred 114 into a locked BTC 116 state within a multisig address. Once the newly minted DBTC is in the DBTC repository 102, the user may perform a DBTC transfer 118 to transfer the ERC20 compliant tokens to the user's Ethereum wallet 106 to allow transactions to take place on the Ethereum blockchain. In embodiments, the amount of DBTC minted may be equivalent to the original amount of BTC transferred by the user. In other embodiments, transaction fees, for example fees incurred during the validation process as described above, may result in a reduced amount of DBTC minted.

In embodiments, prior to the DBTC transfer 118, a number of verifications may occur. For example, the user's BTC transfer 110 to the Deluge wallet 102 and the user's ownership of the transferred BTC are to be verified, as well as the locked BTC 116 associated within the multisig address. In addition, an Ethereum address generated during minting must be verified as produced by the public key that matches a pay to public key hash (P2PKH) address that initiated the multisig transfer.

When and import is triggered by the user, smart contract 108 provides a locked Bitcoin address for the funds interchange. This locked Bitcoin address is a P2SH payment address that may require, for example, 80% of the validators cooperation before the BTC funds can be released.

To verify that the user transferred the BTC, the cross-blockchain secure transaction network may use a P2PKH bitcoin address. The smart contract 108 may check that at least one of the transaction inputs to P2SH is originated from the user's transaction output, thus verifying that the user owns the bitcoin that was locked.

BTC Relay, which is an Ethereum smart contract that may communicate with the Bitcoin blockchain, may be used to verify both that user's BTC contributions are confirmed to the created BTC address and that the user's Bitcoins are locked to the P2SH. The BTC Relay is represented by the smart contract 108 of FIG. 1. The smart contract is a decentralized entity, working as a conduit between user requests submitted to the cross-blockchain secure transaction network via wallet and independent validator machines.

In embodiments, to perform the verification as described above, a BTC Relay, which may be implemented as a smart contract 108, may be used to perform the verifications on the Ethereum block chain. In embodiments, BTC Relay, as an Ethereum smart contract, is able to address cross-chain interoperability, such as token transactions, between Bitcoin and Ethereum by using the series of transactions and validations across the Bitcoin and Ethereum blockchains. Because Bitcoin cannot verify information from other blockchains, an important step in the transition process is the parallel communication and verification across the disparate blockchains. BTC Relay facilitates this by functioning as an Ethereum smart contract that enables a trust-free means of certifying that a Bitcoin transaction took place. The cross-blockchain secure transactions network utilizes BTC Relay to verify that the given transaction is recorded on the Bitcoin network.

In embodiments, BTC Relay uses Bitcoin's block header to create a miniature version of the Bitcoin blockchain—implementing Bitcoin Simplified Payment Verification (SPV). A BTC Relay smart contract stores the block headers and uses the underlying Merkle Root, to verify transactions, enabling other smart contracts to verify that the given Bitcoin transaction has been confirmed sufficiently on the Bitcoin blockchain. A Merkle Root, is the hash of all the hashes of all the transactions that are part of a block in a blockchain and serves to encode blockchain data more efficiently and securely.

In embodiments, if the user wishes to use the cross-blockchain secure transactions network to transition from DBTC used on the Ethereum blockchain to BTC tokens on the Bitcoin block chain, the user may perform a transfer 120 from the Ethereum wallet 106 to the DBTC repository 102b. For example, the user may wish to synchronize tokens between and/or return tokens from the Ethereum ERC20 ecosystem and the Bitcoin blockchain, and convert DBTC back into an equivalent amount of BTC by initiating a cross-blockchain secure transaction export transaction.

In embodiments, the export transaction may create a BTC and Ethereum address pair that corresponds to the same public key, and send DBTC to the repository 102b. A smart contract 108 may be initiated via the Deluge wallet 102 to signal a burn (destruction) of the DBTC tokens and to record the burn event on an Ethereum log. In embodiments, this may signal the burn event 122 to a plurality of validators 124.

In embodiments, the validators 124 may listen for burn events and trigger the export process upon observing the DBTC burn. When the validators 124 observe the DBTC burn event, for example on the Ethereum log, and upon execution of the burn, each validator creates a bitcoin transaction with the appropriate amount of BTC owed to the user consisting of the unspent output from bitcoin transactions (UTXO) that sent BTC 116 to the multisig address. The validators 124 then send their signature 126 to a smart contract.

In embodiments, throughout this process, a majority of validators are required to sign the transaction before any BTC can be released to the user's Deluge wallet 102, in order to prevent mishandling of funds, as described in the Validators and Consensus section below.

Finally, the Deluge wallet 102 awaits the log events on the blockchain to collect the signatures, construct the Bitcoin transaction, and submits it to the bitcoin blockchain. The user then receives the corresponding BTC amount 128 into the Deluge wallet 102 (less any transaction and mining fees incurred during the validation process described above), and the export process is complete. The user may then transfer BTC 130 to the user's Bitcoin wallet 104. In this way, in embodiments, behavior of BTC and DBTC may be synchronized between the bitcoin and Ethereum blockchains, such that BTC that is transferred to the Ethereum blockchain and results in minting of DBTC in the import process may not be used until such time as a corresponding amount of DBTC is burned in the export process, at which time the BTC may then be released to the party who burned the DBTC.

As mentioned above, a robust and distributed network of third-party validators 124 are used to evaluate and come to consensus on the validity of cross-blockchain secure transactions by joining together in consensus protocols and cryptographically signing valid transactions. In embodiments, Validators 124 play a key role in monitoring and approving the DBTC-to-BTC interchange requests and maintaining the 1:1 BTC-to-DBTC relationship. In order to achieve consensus, in embodiments, 80% of Validators must approve DBTC burns and sign DBTC to BTC transaction requests for the cross-blockchain secure transactions network.

In embodiments, validators 124 may be used to safeguard the transaction process based on brand reputation and experience. Validators 124 are to conform to rigorous operational criteria, including: (1) high availability and uptime; (2) expediency with verifications and signatures; (3) secure server and validator key management; and (4) they must self-deploy and/or run the required version of the validator service, among other necessary services.

Validators 124 responsibilities include: (1) key management and safekeeping of P2SH addresses; (2) running Raft consensus nodes for tracking UTXOs, where Raft is a protocol with which a cluster of nodes can maintain a replicated state machine—the state machine is kept in sync through the use of a replicated log; (3) confirmation of DBTC burns during the export process and independent construction of the BTC transaction script used to spend the desired amount from the DBTC burn; and (4) calculating the signature and publishing it to the Ethereum blockchain. Raft is a distributed consensus algorithm to solve the problem of getting multiple servers to agree on a shared state, (e.g. available UTXOs) even in the case of individual server failures. An advantage of consensus algorithms is that they greatly facilitate reliable distributed systems that can survive failures of some of its members.

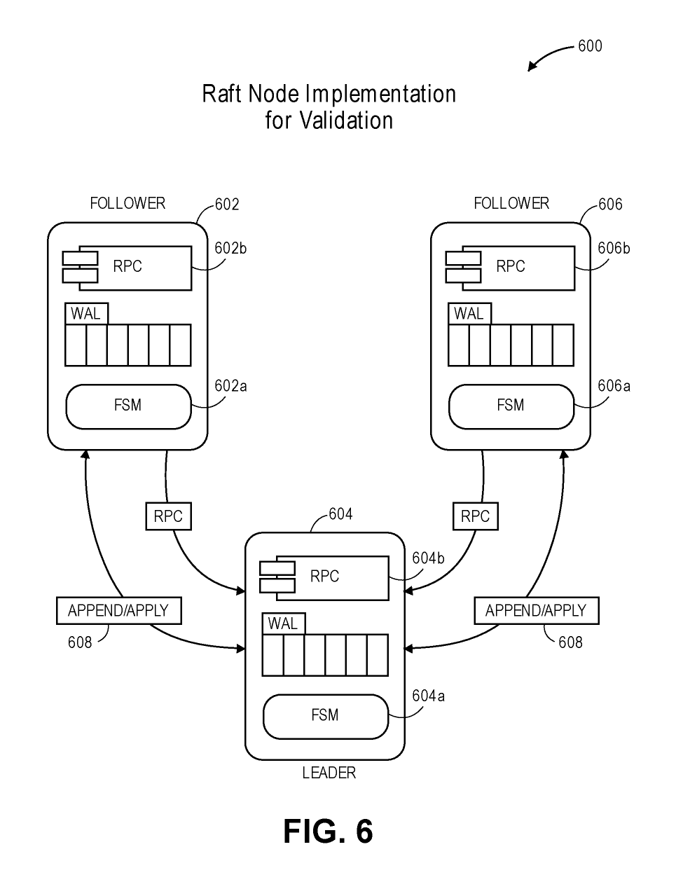

Efficient and reliable tracking of UTXOs may be required for accurate UTXO selection and constructing BTC transactions. Validators 124 may be responsible for tracking the available UTXOs using a Raft-based consensus algorithm (described below with respect to FIG. 6) to achieve multi-system consensus on the availability of the given UTXO.

With respect to UTXO, Bitcoin transactions are composed of inputs and outputs, and a bitcoin address balance may be the sum of all values of UTXO associated with a given address. For example, when a user requests a transaction to “send X bitcoins to address Y,” the Deluge wallet 102 is to select one or more UTXOs with an aggregate value greater-than or equal to the target value plus mining fees.

Validators 124 have the responsibility of tracking the available UTXO addresses and executing an algorithm for efficient UTXO selection. As discussed above, when a user requests to export DBTC to BTC, validators 124 consensus is responsible for UTXO selection to release BTC from the selected UTXOs to the party who exported the DBTC to BTC.

In embodiments, a Raft-based protocol for distributed consensus in tracking UTXOs for the given P2SH addresses may be used. This may ensure that there is an agreed upon pool of UTXOs for selection at any given time.

In embodiments, in addition to any necessary third-party mining and gas fees (fees paid to miners for creating the blocks that make up the blocks on the respective blockchains) paid to the Bitcoin and Ethereum networks during the user's transaction processes, the cross-blockchain secure transaction network may collect a transaction fee, (e.g. 0.7%) for importing from BTC to DBTC and/or for exporting from DBTC to BTC. In embodiments, all transaction fees may be collected in DBTC, or other networked-backed tokens, and put into a transaction reward pool as incentives for users of the system and validators as described further with respect to FIG. 6. The users of the system may be referred to as transactors.

Cross-blockchain secure transaction network users and validators may access the reward pool via D-Tokens and the D-Token smart contract. D-Tokens may be both given to the Validators as compensation for confirmation of network transactions based on their negotiated contract and may be awarded to users based on the number of transactions made and transaction volume. D-tokens may be burned when the holder of D-Token withdraws the prorated amount of DBTC in exchange.

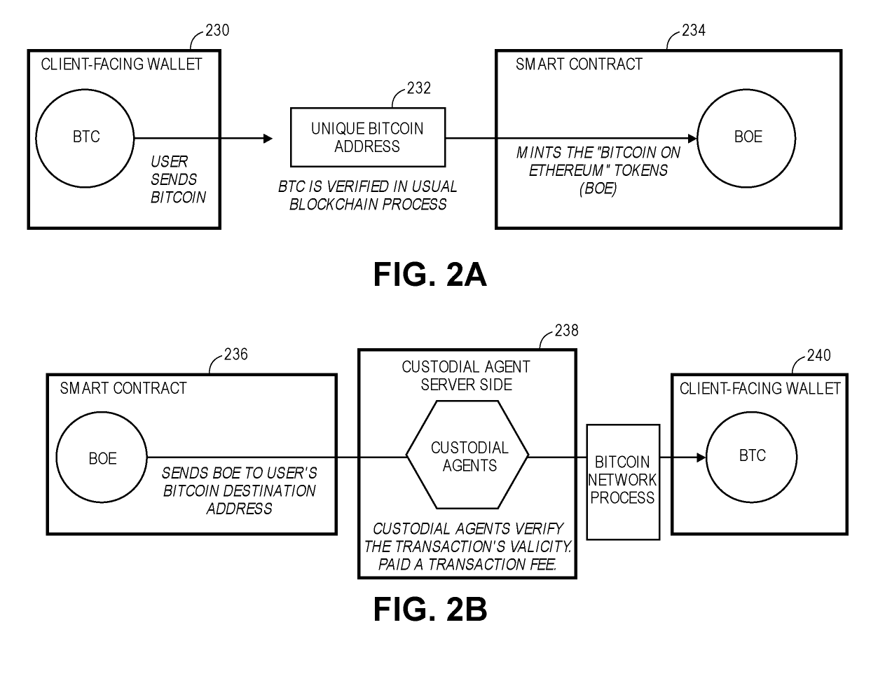

FIGS. 2A-2B are example flow diagrams illustrating, respectively, methods for exporting and importing tokens between a Bitcoin blockchain and an Ethereum blockchain, in accordance with various embodiments. As discussed above, in legacy implementations Bitcoin are not useable on the Ethereum blockchain; to do so requires using a third-party trading desk to trade bitcoin tokens, BTC, for Ethereum tokens, ETH. To allow the value of a Bitcoin to be traded on the Ethereum network, BTC transactions may be synchronized with transactions on the Ethereum network, and vice versa. This would create a BTC-backed token on Ethereum, which may be also referred to as Bitcoin on Ethereum (BOE), also known as “Bitcoin Tether,” “BTCT,” or “DBTC.”

FIG. 2A shows an example flow diagram to convert BTC into BOE tokens. BTC may be sent from a user's wallet 230, which may be similar to wallet 104 of FIG. 1, to a unique Bitcoin address 232. In embodiments, that may trigger minting of ERC223 tokens, for example BOE. In other embodiments, the presence of the BTC in the address may trigger a smart contract 234 to mint the BOE. In embodiments one BTC may equal one BOE. BOE may convert back to BTC as shown in FIG. 2B (described below) during export from BOE to BTC.

In embodiments for converting BTC to BOE, a BTC token may be burned (destroyed), or in other embodiments may be locked, for example, by sending by BTC relay the BTC token to a particular address that may never be used as a source address. In embodiments, proof of ownership of the BTC may be provided, for example, by taking a Bitcoin private key and turning it into an Ethereum address. In embodiments, a hash table may be created for mapping so this needs to only be done once. If the BTC goes to the correct address, an amount of BTCT may be minted on the Ethereum blockchain by Smart Contract 234 that is equal to the amount of BTC. In this way, a foundation may be created to issue proof of ownership for security and to put a user's mind at ease.

The Smart contract 234 on the Ethereum blockchain issues Contract Tokens (CT) and/or BOE/BTCT tokens, may obtain, confirm, or prove that Bitcoin was sent to be converted to BOE/BTCT. The Smart Contract 234 may contain ERC20 functions and specification, such as transfer, as well as ERC223 specification. The Smart Contract may be able to determine which Bitcoin addresses are approved. The Smart Contract may include a burner, for example, a burner (to turn DBTC back into Bitcoin). The Smart Contract may require gas. Gas may be provided by BOE/BTCT, ETH, or the like.

The Smart Contract may comprise an import function to turn a Bitcoin private key into an Ethereum public key. The import function may use, for example, BTC Relay. The import function may verify the Bitcoin transaction and relay the transaction to the Ethereum Smart Contract. The import function may have a function input comprising the Bitcoin transaction wherein the Bitcoin was sent to the unique Bitcoin address. The import function may have a functional output that associated the Ethereum public key with the received Bitcoin transaction.

The import function may work only once per transaction. A mapped hash table may track all transactions. BOE may be exchanged for ETH.

FIG. 2B shows an example flow diagram to convert BOE into BTC. In embodiments, during export from BOE to BTC, an Ethereum smart contract 236 may generate a transaction on the Ethereum network, which may be verified and signed by custodial agents 238. The custodial agents 238 may also be referred to as proof-of-stake or proof-of-ownership miners or as “Miners.” Once verified, the transaction is written to the Bitcoin block chain and the user has Bitcoin placed back in his wallet 240.

Transaction fees of the custodial agents 238, miners and/or the smart contract(s) may be paid, for example, in contract tokens (CT) and/or paid in BOE and distributed to CT, which may be held by custodial agents 238 or miners. Transaction fees may be distributed as, for example, dividends among CT holders. In the course of verifying transactions or separately, miners may mine a cryptocurrency such as CT and/or BOE. Cryptocurrency mined by miners may be sold or conveyed, such as to parties desiring to perform transactions on or relating to BOE.

A similar system may be created to work with BitCash® or other cryptocurrencies. In embodiments, the system may be started without an initial coin offering (ICO). Contract Tokens (CT) may be distributed to trusted parties with no charge. Proceeds may come from tokenized transaction fees. In embodiments, transaction fees may be on the order of, for example, 1% to 0.2%.

In embodiments, in exporting BTCT to BTC, BTCT may be burned (destroyed), for example, by sending the BTCT to a particular address that may never be used as source. In embodiments, proof of ownership may be accomplished by the user providing hash of a pre-image. In this way, a foundation may be created to issue proof of ownership for transaction security. Fees, such as transaction or other fees, may be deducted in an Ethereum smart contract token. In embodiments, 3-5 counter parties may be used to control the burn address. Custodial agents or miners may subscribe to events or otherwise call out all transactions that need to be signed. Verifications can be made to determine if custodial agents or miners can counter-sign based on set rules. If they can countersign, the transaction is sent out to the Bitcoin network.

Embodiments of the processes shown in FIGS. 2A-2B may use the same hash to convert a Bitcoin address to Ethereum and vice-versa, so no additional information may be needed from a user.

In legacy approaches in which BTC and ETH are exchanged, by the time a block is mined to confirm the transaction, the exchange rate between BTC & ETH has often changed. Customers, as a result, end up getting less than what they were promised at the time of the transaction and may feel cheated. Converting ETH or any other ERC20 token to BTCT, in contrast, may be relatively quick. Since BTCT would be tethered to the cost of BTC, this problem of price spikes and slow transfer rate would not occur.

In embodiments statistics about BTCT & BTC transfers may be displayed to users along with a changing BTC address. This may also include a list of custodial agents or miners, their status, and how to contact them. It may also show the current transaction times to align with customer expectations.

There may be a Bitcoin wallet software that can create an Ethereum address and make programmatic calls on the Ethereum block chain. This software may be able to talk to Bitcoin and Ethereum using the same private key. In embodiments, for any Bitcoin address, the wallet may generate an Ethereum public key. When Bitcoin is sent to the particular address that may be locked (or in embodiments may never be used as source address), the Bitcoin may then be converted to BOE. The BOE may be sent to Ethereum wallet. The wallet may then be able to make function calls on Ethereum, for example via the web3.js library.

In embodiments, custodial agents or miners may be able to log in to see a listing of their pending transaction confirmations. In embodiments, they could be given application programming interfaces (APIs) to automate their confirmation process. In embodiments, there may be a peer-to-peer (P2P) network where custodial agents or miners can interact with each other securely and trade among themselves.

Export function for turning BOE back to Bitcoin. The export function may have a functional input comprising a BOE amount (which may be, for example, a BOE token or token amount to transfer plus fees), a destination Bitcoin address, and a hash of a pre-image of the BOE before it is burned that proves identification. The export function may include functional outputs comprising Ethereum events (e.g., Ethereum logs).

Custodial agents or miners may be parties who verify and sign the Ethereum transactions when turning BOE into BTC. Once a transaction has enough verifying signatures, the transaction may be considered verified and may then be written to the Bitcoin blockchain. In embodiments, custodial agents or miners cannot initiate transactions; they can only sign (provide a signature for) transactions.

Custodial agents or miners may monitor or “listen” to the Ethereum blockchain and see burn of BOE, which constitute requests for providing a signature. In a first example, a smart contract may initiate a transaction, multiple transactions may be bundled together for verification, and the event may be publicized by being written to the monitored Ethereum blockchain. In a second example, custodial agents or miners may see a request for signature by subscribing to receive Ethereum events.

Custodial agents or miners may be required to provide a security bond. Custodial agents or miners may also be rated by users and/or metrics regarding transfers and requests for transfers to monitor their performance.

Custodial agents or miners may be part of a P2P network, to allow custodial agents or miners to communicate with one another. For each transaction, each custodial agent or miner may test the transaction and may decide to append the custodial agent's or miner's signature (or not). The transaction may then be passed on to another or next custodial agent(s) or miner(s).

Embodiments may include public monitoring websites that may allow review of statistics of the system. For example, the public monitoring website may display all completed transfer of BOE, changing unique Bitcoin address, a list of custodial agents or miners that may include contact information, and the health or status of the system.

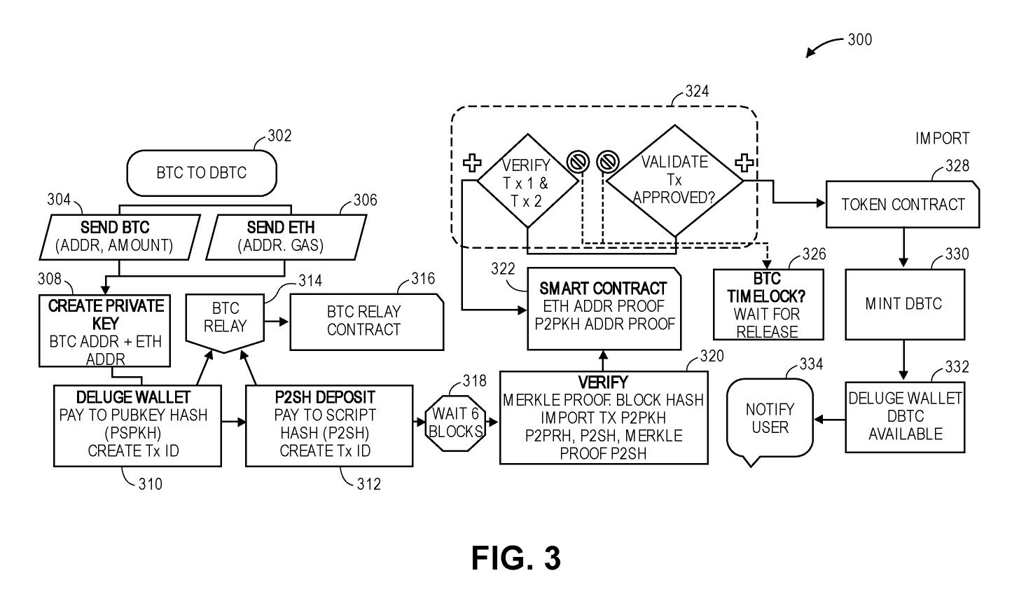

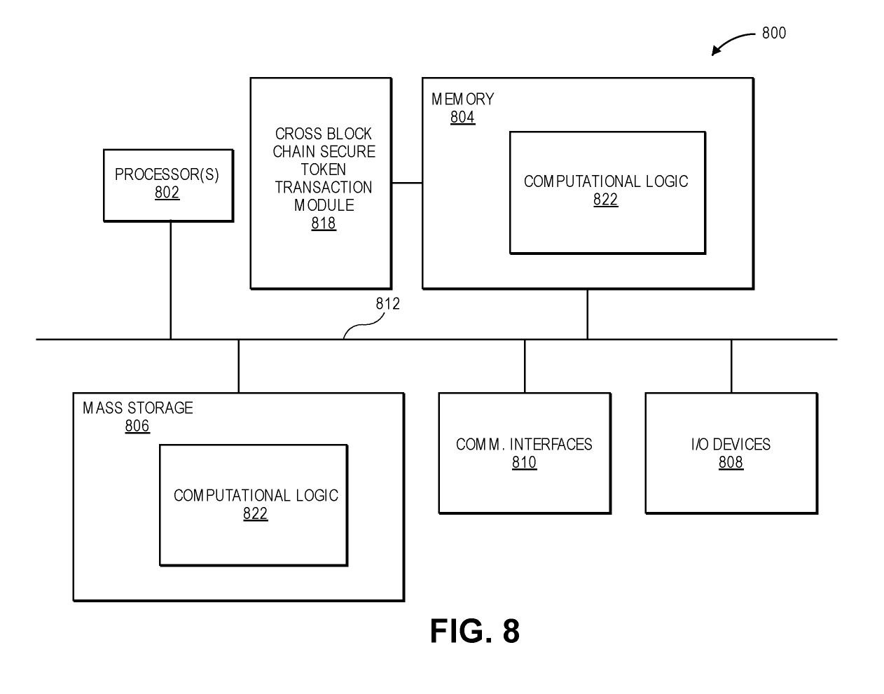

FIG. 3 is an example detailed flow diagram illustrating a method for exporting a token on a Bitcoin blockchain to a token on an Ethereum blockchain, in accordance with various embodiments. In embodiments, the method or portions thereof may be performed at least by the smart contract 108 and Deluge wallet 102 of FIG. 1, and module 818 of FIG. 8. FIG. 300 shows a process 300, with related components, that may start at block 302.

At block 304, the process may cause a BTC to be sent that includes an address and an amount of the BTC in tokens or fractions thereof. In parallel, at block 306, the process may cause an Ethereum token to be sent that includes an address, and gas.

At block 308, the process may cause a private key to be created. In embodiments, the private key may be based on the BTC address and the Ethereum address from blocks 304 and 306, respectively.

At block 310, the process may cause the private key to be sent to the Deluge wallet, which may be similar to Deluge wallet 102 of FIG. 1. In embodiments, the Deluge wallet may pay to a public key hash (P2PKH) and create an associated transaction identifier.

At block 312, the process may cause a pay to script hash (P2SH) to be performed and cause an associated transaction identifier to be created.

At block 314, the process may cause the result of blocks 310 and/or 312 to be sent to the BTC relay to provide cross-blockchain communication via the BTC relay contract.

At block 316, the BTC relay smart contract may receive information from the BTC relay to facilitate cross-blockchain communication.

Returning to block 312, at block 318 the process may cause a wait 6 block chain blocks. In embodiments, the number of block chain blocks for waiting may be varied.

At block 320, the process may cause transactions to be verified. In embodiments, the verification may include Merkle Proof, block hash import transaction, P2PKH, P2PRH, and/or P2SH verification.

At block 322, the process may cause a smart contract to be invoked using the output of the verify block 320 to perform an Ethereum address proof and a P2PKH address proof.

At block 324, the process may cause verification and validation of the transactions to be conducted. If the verification and validation is not completed within a determined period of time, then the process may proceed to block 326, to wait for a release of a BTC time lock.

Otherwise, if the verification and validation is completed within the determined period of time, then the process may proceed to block 328 where a token contract may be instantiated.

At block 330, the process may cause a DBTC to be minted (generated).

At block 332, the process may cause the minted DBTC to be stored in the Deluge wallet, which may be in the private address on the Ethereum blockchain.

At block 334, the process may cause the user to be notified that the minted DBTC is available for access in the Deluge wallet.

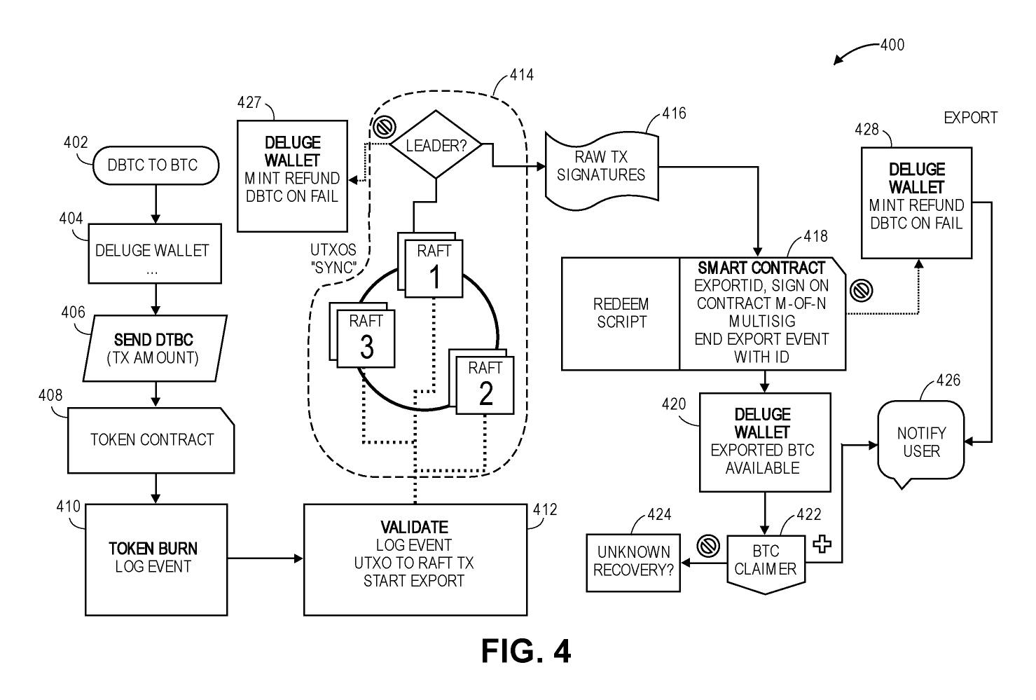

FIG. 4 is an example detailed flow diagram illustrating a method for exporting a token on an Ethereum blockchain to a token on a Bitcoin blockchain, in accordance with various embodiments. In embodiments, the method or portions thereof may be performed at least by the smart contract 108, Deluge wallet 102, validators 124 of FIG. 1, and module 818 of FIG. 8. FIG. 400 shows a process 400, with related components, that may start at block 402.

At block 404, the process may cause DBTC to be deposited into the Deluge wallet.

At block 406, the process may cause DBTC to be sent, including the transaction amount, to a token smart contract.

At block 408, the token smart contract may receive the DBTC and transaction amount.

At block 410, the process may cause a token burn of the DBTC tokens to be initiated. In embodiments, the burn may be recorded as a log event in the Ethereum blockchain.

At block 412, the process may cause the token burn to be validated. In embodiments, the validation may be triggered by the log event.

At block 414, the process may cause the token burn to continue to be validated by waiting on validators, such as validators 124 of FIG. 1, to agree on the validity of the token burn. In embodiments, if the token burn cannot be validated, then the process may proceed to block 427, where a DBTC refund may be minted and the minted DBTC added back to the Deluge wallet.

Otherwise, at block 416, the process may cause the raw transaction signatures from the validators to be aggregated.

At block 418, the process may cause a smart contract to be initiated to determine if there are sufficient validated signatures from the validators. If there are insufficient validated signatures, then the process may proceed to block 428 where the DBTC is minted and refunded to the Deluge wallet of the user, who then, at block 426, may be notified of the refund.

Otherwise, if there are sufficient validated signatures from the validators, then the process may cause a RedeemScript to be generated to be used to redeem previously locked BTC.

At block 420, the process may then cause the unlocked BTC to be received into the Deluge wallet.

At block 422, a BTC claimer process may be initiated. If the BTC claimer process is not successful, then at block 424 a recovery process may be initiated. In embodiments, the BTC may sent to the address specified at the time of the burn. If there was an error, it is lost.

Otherwise, at block 426, the process may cause the user to be notified that exported BTC are available in the Deluge wallet.

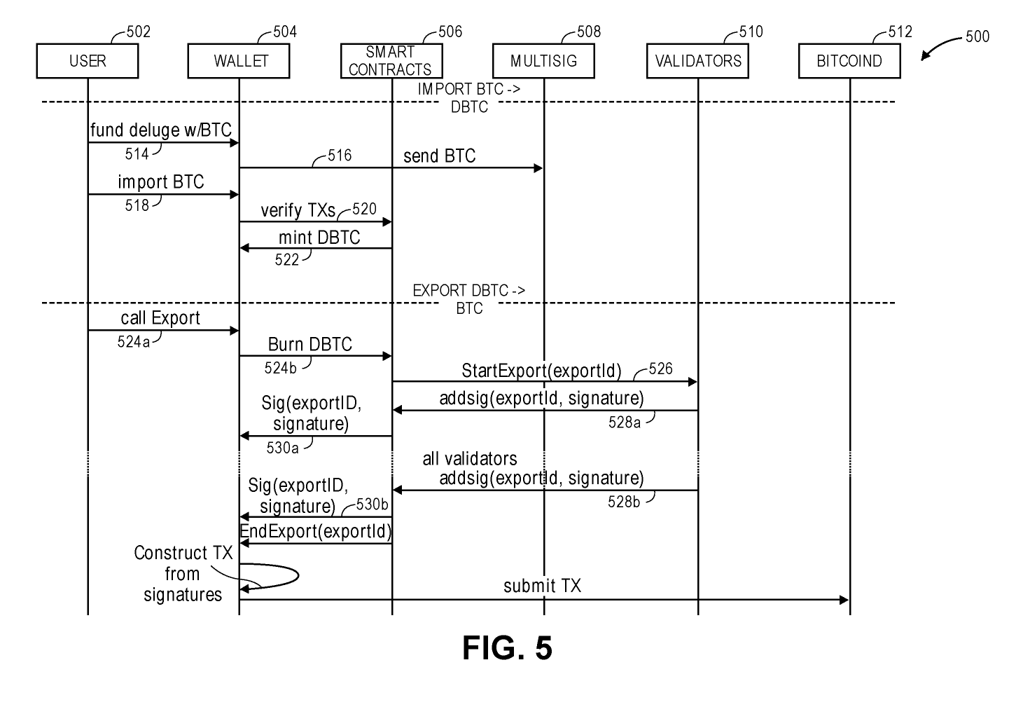

FIG. 5 is an example multiple-entity timing/interaction diagram for importing Bitcoin tokens to Ethereum tokens and exporting Ethereum tokens to Bitcoin tokens, in accordance with various embodiments.

In order to bridge and/or sychronize transactions across the Bitcoin and Ethereum networks, the cross-blockchain secure transaction network may include the following: (1) smart contracts deployed on the Ethereum network that may include: (a) a Deluge Network (DN) smart contract, (b) a token smart contract, and (c) a D token contract; (2) BTC Relay sync services and Relay smart contract; (3) Deluge Wallet for sending and constructing Deluge transactions; (4) P2SH address for locking Bitcoins; and (5) validators and a validator network.

In embodiments, a DN smart contract is responsible for managing Deluge import/export transactions and transaction verifications, including with a BTC Relay contract. A token contract may support DBTC mint and burn activities.

A D token smart contract manages a reward pool. A reward pool may include all transaction fees in the cross-blockchain secure transaction network collected in DBTC (or in other network backed tokens) as incentives for users of the system and validators. Other aspects of D tokens are discussed below.

The Deluge wallet is a software wallet that is controlled by the user. The user may run this software on the user's computer; the user generates keys and stores them for the user's use. An import or export transaction creates a Bitcoin and Ethereum address pairs derived using the secp256k1 ECDSA (Elliptic Curve Digital Signature Algorithm) public key. Transactions may only be validated and executed if the addresses correspond to the same private key claiming the exchange of funds.

BTC Relay Smart Contract. Because Bitcoin cannot verify information from other blockchains, it is important that parallel communication and verification across the disparate blockchains occur. BTC Relay facilitates this by functioning as an Ethereum smart contract that enables a trust-free means of certifying that a Bitcoin transaction took place. BTC Relay is used to verify that the given transaction is recorded on the bitcoin network. Specifically, BTC Relay uses Bitcoin's block header to create a miniature version of the Bitcoin blockchain—implementing Bitcoin SPV. A BTC Relay contract on Ethereum stores the block headers and uses the underlying Merkle Root to verify transactions, enabling other smart contracts to verify that the given Bitcoin transaction has been confirmed sufficiently on the Bitcoin blockchain.

With respect to diagram 500, cross-blockchain secure transaction network import and export flow may be diagrammed as shown. Entities in the multiple entity timing diagram include the user 502, that represents the individual who is submitting the import or export requests. The Deluge wallet 504, which may be similar to Deluge wallet 102 of FIG. 1, is a software solution that assists the user in storing public and private keys, and aids with constructing transactions. The smart contract 506 may be decentralized and run on the Ethereum network. Multisig 508 represents the multisig transaction and P2SH address on the Bitcoin network. Validators 510, which may be similar to validators 124 of FIG. 1, represent independent entities used during the export verification process. Bitcoin 512 represents a Bitcoin node that exposes a remote procedure call (RPC) endpoint.

Import transactions. At 514, the user 502 initiates an import transaction. At 516, the Deluge wallet 504 automatically creates BTC and Ethereum (or ERC20 compliant) address pairs that correspond to the same public key, and sends it to the multisig 508 P2SH address on the Bitcoin network. At 518, the user transfers BTC to the Deluge wallet 504. During Deluge import (sending BTC for DBTC), user sends BTC to a P2SH address specified by the smart contracts 506. The Bitcoins are locked at this address until a future time when a user requests Deluge export (sending DBTC for BTC) and, for example, 80% of the validators agree.

At 520, the Deluge wallet 504 initiates a verify transaction (verifyTx) with a smart contract 506, which ultimately triggers DBTC minting at 522 if verification is successful. The network uses BTC Relay smart contract to verify on the Ethereum blockchain that the given transaction in fact took place on the bitcoin blockchain. Prior to minting DBTC for use on the Ethereum blockchain, a smart contract verifies both the user's transfer of BTC to the Deluge Wallet and that user's ownership of the same BTC once it has been locked into the multisig 508 address. In embodiments, to verify that the user transferred the BTC, a P2PKH bitcoin address may be used. The smart contract checks that at least one of the transaction inputs to P2SH is originated from the user's transaction output, thus providing the check to the condition that the user owns the bitcoin that was locked. A BTC Relay is used to verify both that the user's BTC contributions are confirmed to the created BTC address and that the user's Bitcoins are locked to the P2SH. If verification is successful, a token smart contract 506 mints the DBTCs to user's Ethereum address in the Deluge wallet 504.

Export transactions. During Deluge export, the user, via the Deluge Wallet, triggers a token smart contract DBTC burn 524a, 524b. Smart contract 506 logs the burn event on the Ethereum blockchain, where validators (or custodial agents) listen for burn events and trigger the export process upon observing the DBTC burn 526. Validators independently construct and sign (with their respective private keys) the raw bitcoin transaction by selecting UTXOs that are optimal for the requested transaction amount and post the signature to the Deluge smart contract or Ethereum logs 528a, 528b. When enough M-of-N signatures are posted, the smart contract generates an Ethereum event (or log message) notifying the wallet 530a, 530b of validation. The user, via the wallet, will retrieve the validator signatures, transaction metadata, and RedeemScript from the Deluge smart contract. RedeemScript is a list of validator public keys required to verify the transaction was signed by M-of-N validators. The wallet constructs the multisig bitcoin transaction and submits to the Bitcoin blockchain. The user then receives the corresponding BTC amount into the Deluge Wallet (less any transaction and mining fees incurred during the validation process described above), and the Export process is complete.

Deluge Import/Export Cycle Times. In one embodiment, the rough cycle time estimate from the start of an import/export process to its completion may be as follows. Import uses bitcoin protocol and BTC Relay for transaction verification. An estimation of import cycle time is ˜75 minutes which includes the following steps: (1) send BTC to Deluge Wallet from another wallet address (1 bitcoin block time, ˜10 minutes); (2) send BTC to P2SH address to lock BTC (1 bitcoin block time, ˜10 minutes); (3) send import request to smart contract (wait 6 bitcoin blocks for confirmation, ˜60 minutes to ensure BTC Relay picked up the P2SH transaction); and (4) mint DBTC and see it available on the Deluge Wallet (6 Ethereum blocks, ˜1.5 minutes plus additional time to execute required verification methods between Deluge smart contract and BTC Relay smart contract.

Export starts on the Ethereum network for processing and uses bitcoin protocol for completing the multisig transaction. An estimation of export cycle time is ˜15 minutes which includes the following steps: (1) send export request to smart contract which triggers the DBTC burn event (6 Ethereum block time, ˜1.5 minutes); (2) validators pick up the burn event, independently construct the raw transaction and sign (transaction time would depend on the network latency for the Raft nodes and network infrastructure); (3) smart contract notifies the Deluge Wallet when majority of the Validators have signed. Deluge Wallet constructs the multisig and submits to the bitcoin network to complete the claim (1 bitcoin blocktime ˜10 minutes).

D tokens. In implementation embodiments, D tokens may be used to claim funds in transaction fee pool. D tokens will be burned if the holder withdraws a prorated amount corresponding to D tokens from the pool. In embodiments, D tokens will be airdropped (awarded) based on number of transactions and transaction volume. D tokens may be awarded to transactors. In embodiments, the total supply of D token may be limited to 10,000,000 (10M) tokens. In embodiments, D tokens may be used for governance, such as voting for validators, governance changes and such.

In embodiments, D tokens may have the following characteristics: (1) D token distribution: (1a) a sponsoring organization may be allocated with 80% of the total D token supply. This pool, for example, may be used for future technology development. (1b) all other validators/partners together may be allocated with 10% of the initial D token supply. Each validator may be given tokens based on the negotiated contract. (1c) 10% of the D token pool may be used for rewards: 9% may be allocated to transaction rewards, 1% may be reserved for airdrop (award) promotions.

(2) The right to claim transaction fees. (2a) All the transaction fees in the network may be collected in DBTC (and/or other backed token such as D tokens) and put into the transaction fee pool. (2d) D token holders have the right to burn D tokens in exchange for prorated amount of DBTC in the transaction fee pool anytime. For example, if the total D token supply is 10 million, and a holder has 200,000 D tokens (2% of the total supply), and there are 100 DBTC in the transaction pool at that point, the holder can choose to burn 200,000 D tokens and get 2 DBTC. After the burning, the total supply of D token is 9,800,000, and the remaining DBTCs in the transaction fee pool are 98. Now these 9,800,000 D tokens may represent all the transaction fees collected and to be collected by the network.

(3) Reward Pool: Transaction Reward (Airdrop). (3a) In embodiments, a daily reward (airdrop) of 0.1% of the remainder in reward pool may be given out. For example, if the total supply of D token is 1 million, 1000 D tokens may be given out as reward in day 1,999 D tokens in day 2, 998.001 D tokens in day 3, and so on. (3b) In embodiments, 30% of the daily reward (airdrop) will be used as transaction volume (# of transactions) reward, 70% may be used as turnover (transaction amount in USD) reward. For example, the formulas may include: Volume Reward A=Volume A/Total Volume*Daily Volume Reward; Turnover Reward A=Turnover A/Total Turnover*Daily Turnover Reward. (3c) The rewards incentivize the import transactions (BTC to DBTC conversion), and daily rewards may be computed at the end of a 24-hour period. The previous day's reward pool may be published for community transparency.

4. Reward Pool: Marketing Promotions (Airdrop). (4a) Airdrop for marketing promotions may be tied to a marketing campaign. This will be a flexible reserve that will be analytically tracked for the effectiveness of the marketing campaign. Functionality will be coded into the smart contract for execution. Marketing campaigns may be based on: whitelisted addresses for D token distribution, D token distribution over a date/time range to anyone registered, or airdrops for anyone that did imports given a range (beyond what is already distributed as part of the transaction reward pool).

FIG. 6 is an example context diagram illustrating an interaction of validators in a Raft node implementation, in accordance with various embodiments. Validators are independent entities responsible for independently signing export requests. In embodiments, validators may be invited and/or recruited based on their brand reputation. In embodiments, validators will follow a decentralized model with an open validator participation given the network governance rules (as discussed below).

Validators may: (1) include built-in operational transparency and metrics for trust; (2) achieve balance between maintaining the integrity of transactions and speed of transactions; and (3) have checks, balances, and incentives to ensure validators are honest.

Validator Keys. For the multisig transaction (discussed above), the Deluge wallet is required to supply the RedeemScript, which is a list of validator public keys required to verify the transaction was signed by the needed M-of-N validators.

Validator Fees. In embodiments, in return for the work performed, validators have a stake in the D token reward pool. In embodiments, traction fees are pooled and managed in the D token contract based on the specific cryptocurrency operation, DBTC, DBCH, etc., and a specific fee percentage collected. For example, fees may start at around 0.7%. When validators sign, they may receive a percent of the D tokens that may be contractually agreed.

Required Minimum and Maximum Number of Validators. In some embodiments, validator design may require an odd number of validators for Raft consensus operations. That coupled with the import/export implementation that uses the bitcoin multisig (with a hard limit of 16 signatures), a minimum number of validators is 3 and maximum number of validators is 15.

Validator operation and duties. Validators provide the needed M-of-N keys required to unlock the multisig bitcoin transaction for exporting. For the signing process, individual validators are to: (1) maintain a list of UTXOs (unspent transaction outputs) to construct the spending transaction signature; (2) listen for an export transaction that includes a token burn event; and (3) Independently construct and sign a raw transaction and post their signature to the smart contract.

Given the probabilistic consistency nature of the bitcoin protocol, network partitions, and potential node failures, in embodiments, each validator is to track to the same set of UTXOs. In embodiments, cross-blockchain secure transaction network made leverage a Raft consensus algorithm for UTXO tracking.

Raft Consensus. Raft is a distributed consensus algorithm to solve the problem of getting multiple servers to agree on a shared state, even in the case of individual server failures. In embodiments, a cluster of nodes may maintain a replicated state machine which is kept in sync through the use of a replicated log. As long as the majority of the nodes are up, system will be fully operational.

Turning now to diagram 600, a Raft network consists of an odd number of 3 or more nodes 602, 604, 606, which may be referred to as a cluster, where each node is in one of 3 states: leader, follower or candidate. Raft works with selecting a leader 604 for the cluster. The leader is responsible for maintaining a replicated log of commands to each follower 602, 606. Each follower 602, 606 appends to its log when receiving an AppendEntry command 608 from the leader, and applies a message to its finite state machine (FSM) 602a, 606a when receiving an Apply command 608 from the leader. If a Leader becomes unavailable or out-of-date, a follower 602, 606 can transition into the candidate state and start a new leader election process. Candidates send out a vote request to all nodes and if it receives a quorum of votes the candidate nodes sets itself as the new leader and increments the election term.

Raft Node Implementation. Raft consensus protocol and etcd library implementation may be leveraged for validators. Etcd is an open-source distributed key value store that provides shared configuration and service discovery for Container Linux clusters. Etcd runs on each machine in a cluster and gracefully handles leader election during network partitions and the loss of the current leader. In embodiments, the usage of the validator consensus uses the standard Raft for leader election and replication. Validator may implement the RPC 602b, 604b, 606b and FSM 602a, 604a, 606a on top of the base Raft protocol. Validators can construct bitcoin transactions using the bitcoin, as referred to in 512 FIG. 5, and the validator's local wallet.

In embodiments, the FSM may include two key/value maps for tracking available and exported UTXOs: (1) a key/value pair of validator_id=>(utxo block height, blockhash); and (2) key/value pairs of exportId=>set(utxo).

The first key/file map stores the height and blockhash of the latest (highest) block that contains a UTXO in the given Validator's replicated log. The leader uses this to determine if there are enough nodes that have a particular UTXO in follower wallets. Using this the leader can select UTXOs that have a blockheight less than the lowest block in the FSM and is visible to all Validators. This allows the leader 604 to select a set of UTXOs that exist for a minimum required number of validator nodes for the spending transaction to succeed.

The second key/value map stores the set of UTXOs for each exportId, sent as a log message from the Deluge Token contract, to complete the export. Each validator may use this set to construct the signature necessary to create the spending transaction. Because, in embodiments, a single leader is selecting the UTXOs, each validator is guaranteed to use the same set, verify that these UTXOs exist and that the exportId is a valid export request.

Raft nodes may implement the following RPCs: (1) UpdateUTXO(uint blockHeight, bytes blockHash)—updates best height/hash for a node; (2) StartExport(uint exportId)—requests exports UTXO set, if none exists the leader will create the set based on lowest best height/hash; (3) EndExport(uint exportId)—requests removes the export_id mapping from the FSM

Overview of the flow. In embodiments, (1) followers 602, 606 make an RPC call to the leader sending in their UTXO best block height (with 6 or more confirmations), blockhash, and node id; (1a) leader 604 then sends an AppendEntry message to all followers 602, 606 with the blockheight/blockhash and follower id; (1b) leader 604 sends Apply when enough followers 602, 606 have received entry; (1c) followers 602, 606 receive Apply message and update their FSM by updating entries for new blockheight/blockhash, follower id pairs.

(2) A validator receives a StartExport log event, and it first checks if the exportId exists in the FSM; (2a) if it does, then the Validator uses the values already replicated to construct the signature. (2b) if not, the validator calls the StartExport RPC with the exportId and amount and waits for a response (timeouts included).

(3) The leader handles a StartExport by: (3a) checking if the exportId was already Apply to the log and responds; (3b) selecting a set of UTXOs from its listunspent output where none of the UTXOs have a blockheight greater than the lowest blockheight in the FSM blockheight/blockhash followers set and the value is greater than or equal to the export amount+fees. If the least height UTXO block does not exist in the leaders wallet the leader will set its state to follower without sending the AppendEntry request; (3c) sending an AppendEntry message containing the UTXO set, amount, and exportId for the export to all followers blocking until a quorum of followers reply, once replicated sends an Apply entry to all followers and responds to the RPC.

(4) The followers receive an Apply message for a StartExport and add the UTXO set, amount and exportId to the FSM.

(5) A validator receives a EndExport log event, checks if the export_id is contained in the FSM and if so makes an EndExport RPC call. (5a) Followers forward EndExport message to the leader; (5b) the leader sends AppendEntry for EndExport; (5c) the leader receives quorum of followers and send Apply message for EndExport; (5d) followers Apply EndExport by removing the exportId→Set(UTXO) from their FSM.

Proof of Validation. Each validator may independently construct and sign (with their respective private keys) the raw bitcoin transaction and post their signature to the Deluge smart contract. ExportID (hash value generated by the token contract on an export), also recorded on the smart contract and Ethereum logs, ensures tracking and transparency of Deluge exports as a proof of validation.

Validator Setup, Installation, and Operational Requirements. In embodiments, validators need to ensure support for: (1) fast and secure network connection; (2) Physical environment and operation is secured with limited access and a firewall; (3) (recommended) Hardware Security Module (HSM) for secure digital key management; (4) support staff to deploy and manage the validator service; (5) follow code upgrade requirements and ensure to run the correct version of software.

Validator Operational Requirements. In embodiments, the following Service Level Agreements (SLAs) are a part of the validator node agreement: (1) high availability and timely response time—to participate in the consensus process, validators need to be highly available with a minimum availability requirement of 99% (˜downtime of 14 minutes/day and 1.7 hrs/week) to 99.9% (˜downtime of 1.4 minutes/day and 10 minutes/week); (2) time assurance for validating and signing export requests within the availability requirements; (3) periodically report on validator system health and other metadata such as CPU, memory, traffic, for operational health monitoring; (4) Run pseudo anonymously to prevent malicious attempts, such as a distributed denial of service (DDoS) attack; (5) provide on-call support to address potential faults, network issues, or illegal activity with an ability to suspend/resume services

Key Management and Revocation. The key management and revocation process may include sweeping UTXOs to a new P2SH address, updating contract, wallet and validators with the new address. This may include: (1) key updates for onboarding new validators and reprocessing existing ones; (2) hacked key situation to invalidate a key on a P2SH address; (3) Peers/Sovereigns to suspend or resume a validator; (4) use of recovery keys

Sweep to Licensed Custodial. To mitigate some potential issues with lost/stolen private keys, the validators can have functionality to generate a ‘sweep’ transaction that spends all the known and confirmed UTXOs into a hard-coded custodial account. In embodiments, the sweep transaction would be logged to a non-public location and would require manual intervention by a trusted party to submit to the bitcoin network after the network is shutdown.

Governance Control and Policy. In embodiments, the cross-blockchain secure transaction network is a trusted system with Validators who are recruited based on brand reputation and interest in in cross-blockchain secure transactions. Validator coordination, such as software updates, may be managed off-chain. Governance may also include: (1) onboarding and offboarding of validators, where validators are ordered based on a ranking protocol which includes D token staking, community votes, reputation based on past performance, term limits set by governance rules, and the like; (2) on-chain management of validators, including validator removal if it fails to meet operational requirements; (3) cryptographic key distribution and rotation for enhanced security; (4) social contract to agree on upgrades and changes to protocol, contract, and other operating agreements; (5) mechanisms for the ecosystem to check on the Validator work, which is an input into validator reputation and ranking protocol.

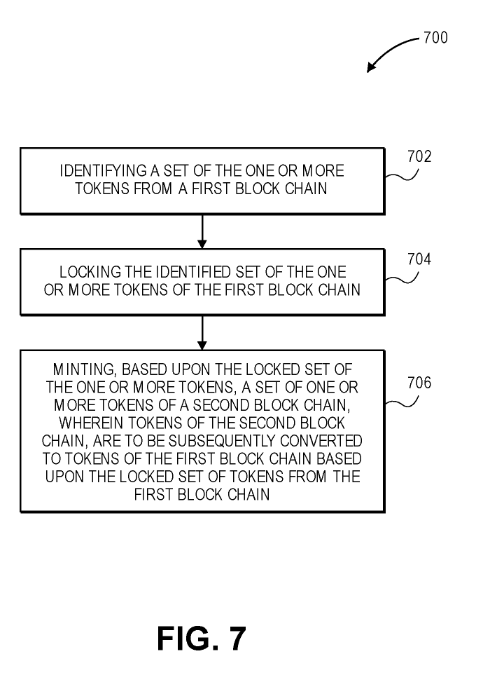

FIG. 7 is an example flow diagram illustrating a method for exporting or synchronizing the behavior of one or more tokens on a first blockchain to one or more tokens on the second blockchain, in accordance with various embodiments. Process 700 and be implemented by, for example, smart contracts 108, Deluge wallet 102, and validators 124 of FIG. 1.

At block 702, the process may include identifying a set of tokens from a first block chain. In embodiments, user may transfer bit coined from the user bitcoin wallet 104 to the users Deluge wallet 102.

At block 704, the process may include locking the identified set of the one or more tokens of the first block chain. In embodiments, this may include locking BTC stored in Deluge wallet 102 using a P2SH Address.

At block 706, the process may include minting, based upon the locked set of the one or more tokens, a set of one or more tokens of a second block chain, wherein tokens of the second block chain are to be subsequently converted to tokens of the first block chain based upon the locked set of tokens from the first block chain. In embodiments, this may include minting a quantity of DBTC based upon the locked BTC from the previous block.

FIG. 8 illustrates an example computing device 800 suitable for use to practice aspects of the present disclosure, in accordance with various embodiments.

For example, the example computing device 800 may be suitable to implement the functionalities of the smart contracts 108 and/or deluge wallet 102. In some embodiments, the example computing device 800 may be suitable to implement the functionalities of validators 124.

As shown, computing device 800 may include one or more processors or processor cores 802, and system memory 804. For the purpose of this application, including the claims, the term “processor” refers to a physical processor, and the terms “processor” and “processor cores” may be considered synonymous, unless the context clearly requires otherwise. The processor 802 may include any type of processors, such as a central processing unit (CPU), a microprocessor, and the like. The processor 802 may be implemented as an integrated circuit having multi-cores, e.g., a multi-core microprocessor. The computing device 800 may include mass storage devices 806 (such as diskette, hard drive, volatile memory (e.g., dynamic random access memory (DRAM)), compact disc read only memory (CD-ROM), digital versatile disk (DVD) and so forth). In general, system memory 804 and/or mass storage devices 806 may be temporal and/or persistent storage of any type, including, but not limited to, volatile and non-volatile memory, optical, magnetic, and/or solid state mass storage, and so forth. Volatile memory may include, but not be limited to, static and/or dynamic random access memory. Non-volatile memory may include, but not be limited to, electrically erasable programmable read only memory, phase change memory, resistive memory, and so forth.

The computing device 800 may further include input/output (I/O) devices 808 such as a display, keyboard, cursor control, remote control, gaming controller, image capture device, and so forth and communication interfaces (comm. INTF) 810 (such as network interface cards, modems, infrared receivers, radio receivers (e.g., Bluetooth), and so forth). I/O devices 808 may be suitable for communicative connections with other systems and/or devices that communicate to facilitate cross-blockchain secure transactions.

The communication interfaces 810 may include communication chips (not shown) that may be configured to operate the device 800 in accordance with a Global System for Mobile Communication (GSM), General Packet Radio Service (GPRS), Universal Mobile Telecommunications System (UMTS), High Speed Packet Access (HSPA), Evolved HSPA (E-HSPA), or Long Term Evolution (LTE) network. The communication chips may also be configured to operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chips may be configured to operate in accordance with Code Division Multiple Access (CDMA), Time Division Multiple Access (TDMA), Digital Enhanced Cordless Telecommunications (DECT), Evolution-Data Optimized (EV-DO), derivatives thereof, as well as any other wireless protocols that are designated as 3G, 4G, 5G, and beyond. The communication interfaces 810 may operate in accordance with other wireless protocols in other embodiments.

The above-described computing device 800 elements may be coupled to each other via system bus 812, which may represent one or more buses. In the case of multiple buses, they may be bridged by one or more bus bridges (not shown). Each of these elements may perform its conventional functions known in the art. In particular, system memory 804 and mass storage devices 806 may be employed to store a working copy and a permanent copy of the programming instructions implementing the operations associated with cross-blockchain secure transactions, e.g., operations associated with providing cross-blockchain secure transactions 818 with features and/or functions as described in reference to FIGS. 1-7. Computational logic 822 may be implemented by assembler instructions supported by processor(s) 802 or high-level languages that may be compiled into such instructions.

The permanent copy of the programming instructions may be placed into mass storage devices 806 in the factory, or in the field, through, for example, a distribution medium (not shown), such as a compact disc (CD), or through communication interfaces 810 (from a distribution server (not shown)).

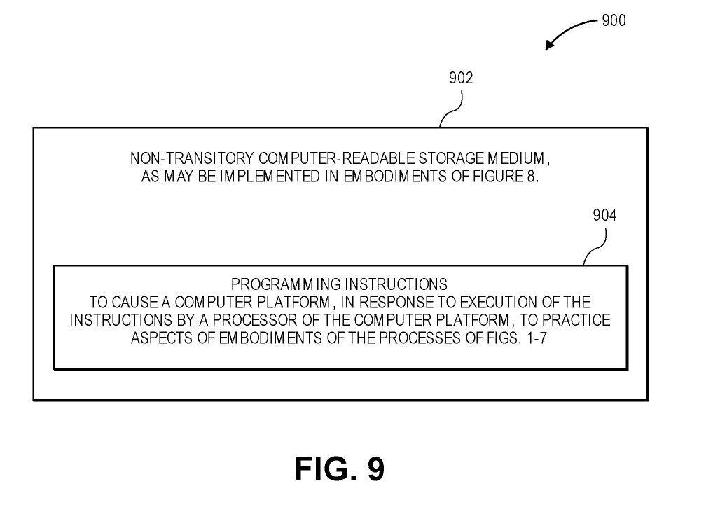

FIG. 9 illustrates an example storage medium having instructions for practicing methods described with references to FIGS. 1-7, in accordance with various embodiments.

As will be appreciated by one skilled in the art, the present disclosure may be embodied as methods or computer program products. Accordingly, the present disclosure, in addition to being embodied in hardware as earlier described, may take the form of an entirely software embodiment (including firmware, resident software, micro-code, etc.) or an embodiment combining software and hardware aspects that may all generally be referred to as a “circuit,” “module” or “system.” Furthermore, the present disclosure may take the form of a computer program product embodied in any tangible or non-transitory medium of expression having computer-usable program code embodied in the medium. FIG. 9 illustrates an example computer-readable non-transitory storage medium that may be suitable for use to store instructions that cause an apparatus, in response to execution of the instructions by the apparatus, to practice selected aspects of the present disclosure. As shown, non-transitory computer-readable storage medium 902 may include a number of programming instructions 904. Programming instructions 904 may enable a device, e.g., a computing platform 800, in response to execution of the programming instructions, to perform operations associated with the functions and operations described in FIGS. 1-7. In alternate embodiments, programming instructions 904 may be disposed on multiple computer-readable non-transitory storage media 802 instead. In alternate embodiments, programming instructions 904 may be disposed on computer-readable transitory storage media 902, such as signals.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof.

Embodiments may be implemented as a computer process, a computing system or as an article of manufacture such as a computer program product of computer readable media. The computer program product may be a computer storage medium readable by a computer system and encoding a computer program instructions for executing a computer process.

The corresponding structures, material, acts, and equivalents of all means or steps plus function elements in the claims below are intended to include any structure, material or act for performing the function in combination with other claimed elements are specifically claimed. The description of the present disclosure has been presented for purposes of illustration and description, but is not intended to be exhaustive or limited to the disclosure in the form disclosed. Many modifications and variations will be apparent to those of ordinary skill without departing from the scope and spirit of the disclosure. The embodiment was chosen and described in order to best explain the principles of the disclosure and the practical application, and to enable others of ordinary skill in the art to understand the disclosure for embodiments with various modifications as are suited to the particular use contemplated.

Thus various example embodiments of the present disclosure have been described including, but are not limited to:

Example 1 is a method, apparatus, and/or system for cross-blockchain and/or synchronization, wherein a first cryptocurrency of a first blockchain is sent to a locked address, an address is created in a second blockchain corresponding to a private key of the first cryptocurrency, and a second cryptocurrency of the second blockchain is minted in the second blockchain by a smart contract.

Example 2 may include the subject matter of example 1, wherein the second cryptocurrency is burned, a miner or a custodial agent verifies validity, and wherein first cryptocurrency is released from the locked address and is sent to an unlocked address in the first blockchain.

Example 3 may be one or more computer-readable media comprising instructions that cause a computer device, in response to execution of the instructions by one or more processors of the computer device, to operate a cross blockchain secure token transaction engine to: identify a set of one or more tokens of a first blockchain; lock the identified set of the one or more tokens of the first blockchain; and generate, based upon the locked set of the one or more tokens, a set of one or more tokens of a second blockchain; wherein the set of one or more tokens of the second blockchain are to be subsequently converted to tokens of the first blockchain based upon the locked set of tokens of the first blockchain.

Example 4 may include the one or more computer-readable media of example 3, wherein to lock the identified set of tokens of the first blockchain is further to: identify a pays to script hash (P2SH) address associated with the identified set of the one or more tokens of the first blockchain; and lock the identified set of the one or more tokens of the first blockchain to the identified P2SH address.

Example 5 may include the one or more computer-readable media of example 4, wherein the P2SH address is specified by a smart contract.

Example 6 may include the one or more computer-readable media of example 4, wherein to generate one or more tokens of the second blockchain is further to: verify ownership of the tokens of the locked identified set of tokens of the first blockchain by a user; and verify the tokens of the locked identified group of tokens of the first blockchain have been stored to a wallet of the user.

Example 7 may include the one or more computer-readable media of example 6, wherein the wallet is to store an indication of one or more tokens of the first blockchain and of one or more tokens of the second blockchain owned by a user.

Example 8 may include the one or more computer-readable media of example 6, wherein the wallet includes address pairs corresponding to the first blockchain and the second blockchain, wherein the address pairs are associated with a public key.

Example 9 may include the one or more computer-readable media of example 3, wherein the computer device is further caused to: identify a set of one or more tokens of the second blockchain; based upon the identified set of one or more tokens of the second blockchain, identify a subset of tokens of the locked set of tokens of the first blockchain; burn the identified set of tokens of the second block chain; and unlock the subset of the set tokens of the locked group of tokens on the first blockchain, based upon the identified group of tokens of the second blockchain.

Example 10 may include the one or more computer-readable media of example 9, the computer device is further caused to store an indication of the unlocked subset of the set of one or more tokens of the first blockchain in a wallet.

Example 11 may include the one or more computer-readable media of example 9, wherein to burn the identified set of tokens of the second block chain is further to: receive a plurality of responses, respectively, from a plurality validator nodes, wherein a response includes an indication of a verification of a burn event; and based upon the received plurality of responses, determine whether the identified set of tokens of the second block chain are to be burned.

Example 12 may include the one or more computer-readable media of example 11, wherein a validator node maintains a list of unspent transaction outputs in the first blockchain based upon the set of one or more tokens of the second blockchain.

Example 13 may include the one or more computer-readable media of example 11, wherein to determine whether the identified set of tokens of the second block chain are to be burned is based upon a Raft consensus algorithm for unspent transaction outputs tracking.

Example 14 may include the one or more computer-readable media of example 3, wherein the first blockchain is a Bitcoin blockchain, and the second blockchain is an Ethereum blockchain.

Example 15 may include the one or more computer-readable medium of example 3, wherein the one or more tokens of the first blockchain are one or more Bitcoins, and wherein the one or more tokens of the second blockchain are ERC20 compatible tokens for the Ethereum blockchain.

Example 16 may include the one or more computer-readable media of example 3, wherein a token includes a portion of a token.

Example 17 is a computer-implemented method, comprising: identifying a set of one or more tokens of a first blockchain; locking the identified set of the one or more tokens of the first blockchain; and generating, based upon the locked set of the one or more tokens, a set of one or more tokens of a second blockchain; wherein the set of one or more tokens of the second blockchain are to be subsequently converted to tokens of the first blockchain based upon the locked set of tokens of the first blockchain.

Example 18 may include the computer-implemented method of example 17, wherein locking the identified set of tokens of the first blockchain further includes: identifying a P2SH address associated with the identified set of the one or more tokens of the first blockchain; and locking the identified set of the one or more tokens of the first blockchain to the identified P2SH address.

Example 19 may include the computer-implemented method of example 17, wherein the address is specified by a smart contract.

Example 20 may include the computer-implemented method of example 17, wherein generating one or more tokens of the second blockchain further includes: verifying ownership of the tokens of the locked identified set of tokens of the first blockchain by a user; and verifying the tokens of the locked identified group of tokens of the first blockchain have been stored to a wallet of the user.

Example 21 may include the computer-implemented method of example 17, wherein the wallet is to store an indication of one or more tokens of the first blockchain and of one or more tokens of the second blockchain owned by a user.

Example 22 may include the computer-implemented method of example 17, wherein the wallet includes address pairs corresponding to the first blockchain and the second blockchain, wherein the address pairs are associated with a public key.

Example 23 may include the computer-implemented method of example 17, further including: identifying a set of one or more tokens of the second blockchain; based upon the identified set of one or more tokens of the second blockchain, identifying a subset of tokens of the locked set of tokens of the first blockchain; burning the identified set of tokens of the second block chain; and unlocking, based upon the identified group of tokens of the second blockchain, the subset of the set tokens of the locked group of tokens on the first blockchain.

Example 24 may include the computer-implemented method of example 23, further including storing an indication of the unlocked subset of the set of one or more tokens of the first blockchain in the wallet.

Example 25 may include the computer-implemented of example 23, wherein burning the identified set of tokens of the second block no chain further includes: receiving a plurality of responses, respectively, from a plurality validator nodes, wherein a response includes an indication of a verification of a burn event; and based upon the received plurality of responses, determining whether the identified set of tokens of the second block chain are to be burned.

Example 26 may include the computer-based method of example 25, wherein a validator node is to maintain a list of unspent transaction outputs based upon the set of one or more tokens of the second blockchain.

Example 27 may include the computer-based method of example 26, wherein determining whether the identified set of tokens of the second block chain are to be burned is based upon a Raft consensus algorithm for unspent transaction outputs tracking.

Example 28 may include the computer-based method of example 17, wherein the first blockchain is a Bitcoin blockchain, and the second blockchain is an Ethereum blockchain.

Example 29 may include the computer-based method of example 17, wherein the one or more tokens of the first blockchain are one or more Bitcoins, and wherein the one or more tokens of the second blockchain are ERC20 compatible tokens for the Ethereum blockchain.

Example 30 may include the computer-based method of example 17, wherein a token includes a portion of a token.

Example 31 may include the computer-based method of example 17, wherein the method is performed by one or more smart contracts.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

What is claimed is:

1. One or more computer-readable media comprising instructions that cause a computer device, in response to execution of the instructions by one or more processors of the computer device, to operate a cross blockchain secure token transaction engine to:
identify a set of one or more tokens of a first blockchain;
lock the identified set of the one or more tokens of the first blockchain; and
generate, based upon the locked set of the one or more tokens, a set of one or more tokens of a second blockchain;
wherein the set of one or more tokens of the second blockchain are to be subsequently converted to tokens of the first blockchain based upon the locked set of tokens of the first blockchain.

2. The one or more computer-readable media of claim 1, wherein to lock the identified set of tokens of the first blockchain is further to:
identify a pays to script hash (P2SH) address associated with the identified set of the one or more tokens of the first blockchain; and
lock the identified set of the one or more tokens of the first blockchain to the identified P2SH address.

3. The one or more computer-readable media of claim 2, wherein the P2SH address is specified by a smart contract.

4. The one or more computer-readable media of claim 1, wherein to generate one or more tokens of the second blockchain is further to:
verify ownership of the tokens of the locked identified set of tokens of the first blockchain by a user; and
verify the tokens of the locked identified group of tokens of the first blockchain have been stored to a wallet of the user.

5. The one or more computer-readable media of claim 4, wherein the wallet is to store an indication of one or more tokens of the first blockchain and of one or more tokens of the second blockchain owned by a user.

6. The one or more computer-readable media of claim 4, wherein the wallet includes address pairs corresponding to the first blockchain and the second blockchain, wherein the address pairs are associated with a public key.

7. The one or more computer-readable media of claim 1, wherein the computer device is further caused to:
identify a set of one or more tokens of the second blockchain;
based upon the identified set of one or more tokens of the second blockchain, identify a subset of tokens of the locked set of tokens of the first blockchain;
burn the identified set of tokens of the second block chain; and
unlock the subset of the set tokens of the locked group of tokens on the first blockchain, based upon the identified group of tokens of the second blockchain.

8. The one or more computer-readable media of claim 7, the computer device is further caused to store an indication of the unlocked subset of the set of one or more tokens of the first blockchain in a wallet.

9. The one or more computer-readable media of claim 7, wherein to burn the identified set of tokens of the second block chain is further to:
receive a plurality of responses, respectively, from a plurality validator nodes, wherein a response includes an indication of a verification of a burn event; and
based upon the received plurality of responses, determine whether the identified set of tokens of the second block chain are to be burned.

10. The one or more computer-readable media of claim 9, wherein a validator node maintains a list of unspent transaction outputs in the first blockchain based upon the set of one or more tokens of the second blockchain.

11. The one or more computer-readable media of claim 9, wherein to determine whether the identified set of tokens of the second block chain are to be burned is based upon a Raft consensus algorithm for unspent transaction outputs tracking.

12. The one or more computer-readable media of claim 1, wherein the first blockchain is a Bitcoin blockchain, and the second blockchain is an Ethereum blockchain.

13. The one or more computer-readable medium of claim 1, wherein the one or more tokens of the first blockchain are one or more Bitcoins, and wherein the one or more tokens of the second blockchain are ERC20 compatible tokens for the Ethereum blockchain.

14. The one or more computer-readable media of claim 1, wherein a token includes a portion of a token.

15. A computer-implemented method, comprising:
identifying a set of one or more tokens of a first blockchain;
locking the identified set of the one or more tokens of the first blockchain; and
generating, based upon the locked set of the one or more tokens, a set of one or more tokens of a second blockchain;
wherein the set of one or more tokens of the second blockchain are to be subsequently converted to tokens of the first blockchain based upon the locked set of tokens of the first blockchain.

16. The computer-implemented method of claim 15, wherein locking the identified set of tokens of the first blockchain further includes:
identifying a P2SH address associated with the identified set of the one or more tokens of the first blockchain; and
locking the identified set of the one or more tokens of the first blockchain to the identified P2SH address.

17. The computer-implemented method of claim 15, wherein the address is specified by a smart contract.

18. The computer-implemented method of claim 15, wherein generating one or more tokens of the second blockchain further includes:
verifying ownership of the tokens of the locked identified set of tokens of the first blockchain by a user; and
verifying the tokens of the locked identified group of tokens of the first blockchain have been stored to a wallet of the user.

19. The computer-implemented method of claim 15, wherein the wallet is to store an indication of one or more tokens of the first blockchain and of one or more tokens of the second blockchain owned by a user.

20. The computer-implemented method of claim 15, wherein the wallet includes address pairs corresponding to the first blockchain and the second blockchain, wherein the address pairs are associated with a public key.

21. The computer-implemented method of claim 15, further including:
identifying a set of one or more tokens of the second blockchain;
based upon the identified set of one or more tokens of the second blockchain, identifying a subset of tokens of the locked set of tokens of the first blockchain;
burning the identified set of tokens of the second block chain; and
unlocking, based upon the identified group of tokens of the second blockchain, the subset of the set tokens of the locked group of tokens on the first blockchain.

22. The computer-implemented method of claim 21, further including storing an indication of the unlocked subset of the set of one or more tokens of the first blockchain in the wallet.

23. The computer-implemented of claim 21, wherein burning the identified set of tokens of the second block no chain further includes:
receiving a plurality of responses, respectively, from a plurality validator nodes, wherein a response includes an indication of a verification of a burn event; and
based upon the received plurality of responses, determining whether the identified set of tokens of the second block chain are to be burned.

24. The computer-based method of claim 23, wherein a validator node is to maintain a list of unspent transaction outputs based upon the set of one or more tokens of the second blockchain.

25. The computer-based method of claim 24, wherein determining whether the identified set of tokens of the second block chain are to be burned is based upon a Raft consensus algorithm for unspent transaction outputs tracking.

26. The computer-based method of claim 15, wherein the first blockchain is a Bitcoin blockchain, and the second blockchain is an Ethereum blockchain.

27. The computer-based method of claim 15, wherein the one or more tokens of the first blockchain are one or more Bitcoins, and wherein the one or more tokens of the second blockchain are ERC20 compatible tokens for the Ethereum blockchain.

28. The computer-based method of claim 15, wherein a token includes a portion of a token.

29. The computer-based method of claim 15, wherein the method is performed by one or more smart contracts.
